(19) United States
(12) Patent Application Publication
(10) Pub. No.: US 2014/0289193 A1
(43) Pub. Date: Sep. 25, 2014

(54) SYNCHRONIZING FORWARDING DATABASES IN A NETWORK DEVICE BACKGROUND

(71) Applicants: Xuyang Zhou, Shanghai (CN); Bibo Ma, Shanghai (CN); Ganglun Li, Shanghai (CN)

(72) Inventors: Xuyang Zhou, Shanghai (CN); Bibo Ma, Shanghai (CN); Ganglun Li, Shanghai (CN)

(73) Assignee: Qualcomm Incorporated, San Diego, CA (US)

(21) Appl. No.: 14/356,105

(22) PCT Filed: Nov. 8, 2011
(86) PCT No.: PCT/CN2011/081911

§ 371 Date: May 2, 2014

(51) Int. Cl. G06F 17/30

(52) U.S. Cl. CPC G06F 17/30581
USPC 707/612

(57) ABSTRACT

Synchronizing forwarding databases in a network device. A first forwarding database may be maintained in a database engine portion of the network device. The forwarding database may include a plurality of entries, each of the entries comprises a synchronization field. The forwarding database may also include a global synchronization value used for the synchronization. A controller in the network device may receive a message indicating one or more changes to a first one or more entries in the forwarding database. The first one or more entries have a first global synchronization value in the synchronization field. Accordingly, the global synchronization value may be changed to a second value and a query may be performed using the first global synchronization value to return changes to the first entries. Changes to other entries in the forwarding database that occur after the global synchronization value is changed may not be part of the query results.

### BACKGROUND

1. Field of the Disclosure

The present invention relates generally to network systems, and more particularly to a system and method for synchronizing a forwarding database with a controller.

2. Description of the Related Art

Communication networks may include various network devices such as computers, servers, routers, switches, bridges, hubs, and other types of network nodes. Data is communicated through the data communication network by passing data packets or frames between the various devices to move the data from a source device to a destination device. In a wide area communication network, such as the Internet, packets may be handled or processed by a plurality of network elements and may cross a multiple communication links as the packets travel from the source device to the destination device.

Certain devices in a network, such as switches, bridges, and routers, manage and regulate network traffic. For example, these devices may analyze received packets and forward them on to another device in the network. When a network device such as a switch receives a packet, the switch retrieves the destination address from the packet and looks up the output port for the destination in a forwarding database. The forwarding database comprises a plurality of tables that comprise mappings between addresses and corresponding ports. The switch then sends the packet to the identified destination port.

A network switching system may create the forwarding database by registering the source address and port information of each incoming packet to the forwarding database. IEEE 802.1D, a standard on Media Access Control (“MAC”) bridges, provides the operation procedures for creating forwarding databases and transmitting and receiving of network packets.

In network systems, it is important for the various network devices (e.g., switches) to synchronize their forwarding databases. Currently, forwarding databases are synchronized between switches by using a queue. The queue records all changes to the tables in the forwarding database, including entry additions, updates, and deletions. The controller in the switch retrieves the changes by reading the queue.

A switch includes a controller which utilizes the information in the forwarding database and a database engine which manages the forwarding database. Because of the mismatch in the processing capabilities of the database engine and the controller, especially in high speed switches, the queue cannot be large enough to record all temporary information waiting to be handled by the controller. To minimize this impact, hardware designers use large First-In-First-Out (FIFO) queues or temporarily halt the database changes when needed, otherwise these changes would be out of synch with the controller.

Furthermore, when multiple changes occur to a single entry before the controller actually know any of them, a common approach to simplify switch design is to record them with multiple records. This design is vulnerable to Denial-of-Service (DoS) attacks, where an attacker can simply change one entry frequently to exhaust the FIFO queue, thereby halting the database synchronization updates.

Accordingly, improvements in the field would be desirable.

### SUMMARY OF THE DISCLOSURE

Various embodiments are presented of a system and method for synchronizing forwarding databases in a network device.

A first forwarding database or table may be maintained in a database engine portion of the network device. The database engine portion may be largely implemented in hardware. Additionally, a second forwarding database or table may be maintained by a controller portion of the network device. The controller portion may be implemented as software executing on a processor of the network device, although other embodiments are envisioned where it is implemented in hardware.

Both the first forwarding database and the second forwarding database may include a plurality of entries. In at least the first forwarding database, each of the plurality of entries may include a synchronization field, among other fields. The first and second forwarding databases may include or use a global synchronization value, e.g., for synchronizing changes of the first forwarding database to the second forwarding database, as discussed in more detail below. Additional fields may also be used for synchronization, such as an update field (e.g., to indicate when an existing field has been updated) and a learning or status field (e.g., to indicate the status of the entry, such as “auto learnt”, “controlled learnt”, “controlled aged”, and/or “auto aged”, among other possibilities). Other fields may be used to assist in synchronization. Note that one or more of the fields used in synchronization may only be present in the first forwarding database and not in the second forwarding database. For example, this synchronization information may not be necessary in the second forwarding database, e.g., since updates may generally occur in the database engine portion and then synchronized to the controller portion rather than the opposite direction. However, synchronization in the opposite direction is still envisioned, e.g., when updates are provided from other network devices. In one embodiment, such synchronizations may occur in a different manner than discussed herein.

During the course of operation, changes may occur in the first forwarding database, e.g., entries may be changed or added by the database engine portion of the database. Accordingly, the first and second databases may become out of synchronization. In one specific embodiment, changes to a first one or more entries in the first forwarding database may be performed. These changes may include the addition of entries or the modification of values of fields in existing entries. Additionally, these entries may have a synchronization value set to the current synchronization value. In response to these changes, or in a periodic fashion, the database engine portion may send a message, such as an interrupt, to the controller to indicate that an update of the second forwarding database should be performed. Accordingly, the controller in the network device may receive a message indicating that changes have occurred.

In response, the controller may change the global synchronization value from the first synchronization value to a second global synchronization value and may also generate a query to determine the one or more changes to the first entries in the first forwarding database. In one embodiment, the query may include or use various values associated with fields in the first forwarding database, such as the global synchronization value, the update value, the status value, etc. In one embodiment, the query may search for those entries having the first global synchronization value and a status field of “controlled learnt”. However, it should be noted that embodiments are envisioned where any combination of the global synchronization value, the update value, or the status value (among other possible fields) may be used.

Accordingly, the query may be performed to return query results (e.g., from the database engine portion to the controller portion). The query results may include the one or more changes to the first one or more entries, e.g., by using the first global synchronization value to identify the first one or more entries.

After the query results have been obtained, various ones of the fields may be reset. For example, entries that have been synchronized may change the update field value from, e.g., “1” (enabled) to “0” (disabled). Similarly, entries that have a status value of “controlled learnt” may be changed to “auto learnt”, e.g., so that they are not returned in a future query for changes made to the first forwarding database. In some embodiments, these changes may be performed by an update engine based on commands sent by the controller.

Additionally, changes to other entries in the forwarding database that occur after the controller changes the global synchronization value to the second global synchronization value are not part of the query results, e.g., since those values may be assigned the second global synchronization value rather than the first. In these cases, when the changes (e.g., modifications or additions) are made, their synchronization fields may be set to the current global synchronization value (which, in this example, is the second global synchronization value), so that these changes may be identified in a subsequent synchronization process. Thus, the global synchronization value may “ping pong” between two different values over the course of several synchronizations to track which entries have or have not been synchronized.

The query results may be used in a variety of manners. As indicated above, the controller may maintain a second forwarding database and may used the query results to update the second forwarding database (e.g., to synchronize the first and second forwarding databases). As another possibility, the query results may be used to update other network devices or other database engine portions of the network device (e.g., where the network device includes a controller portion and several database engine portions, which may need to have their respective forwarding databases synchronized).

### BRIEF DESCRIPTION OF THE DRAWINGS

A better understanding of the present invention can be obtained when the following Detailed Description of the Embodiments is read in conjunction with the following drawings, in which:

FIG. 1 illustrates an exemplary network device, according to one embodiment;

FIG. 2 illustrates an exemplary system including several network devices used to connect two devices in a network, according to one embodiment;

FIG. 3 is a flowchart diagram illustrating embodiments of a method for synchronizing a controller and a database engine of a network device;

FIGS. 4A-4E are exemplary tables illustrating an example corresponding to the method of FIG. 3, according to one embodiment;

FIG. 5 is a state diagram for an entry in an exemplary forwarding table of a filtering database in an Ethernet switch, according to one embodiment; and

FIGS. 6A-6N are exemplary tables and entries corresponding to the state diagram of FIG. 5, according to various embodiments.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the scope of the present invention as defined by the appended claims.

### DETAILED DESCRIPTION OF EMBODIMENTS OF THE DISCLOSURE

### Terms

The following is a glossary of terms used in the present application:

Memory Medium—Any of various types of memory devices or storage devices. The terms “memory” and “memory medium” are intended to include an installation medium, e.g., a CD-ROM, floppy disks, or tape device; a computer system memory or random access memory such as DRAM, DDR RAM, SRAM, EDO RAM, Rambus RAM, etc.; or a non-volatile memory such as flash memory, hardware registers, a magnetic media (e.g., a hard drive), or optical storage. The memory medium may comprise other types of memory as well, or combinations thereof. The term “memory medium” may include two or more memory mediums.

Computer System—Any of various types of mobile or stationary computing or processing systems, including a personal computer system (PC), mainframe computer system, workstation, network appliance, Internet appliance, mobile phone, smart phone, laptop, notebook, netbook, or tablet computer system, personal digital assistant (PDA), multimedia device, or other device or combinations of devices. In general, the term “computer system” can be broadly defined to encompass any device (or combination of devices) having at least one processor that executes instructions from a memory medium.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

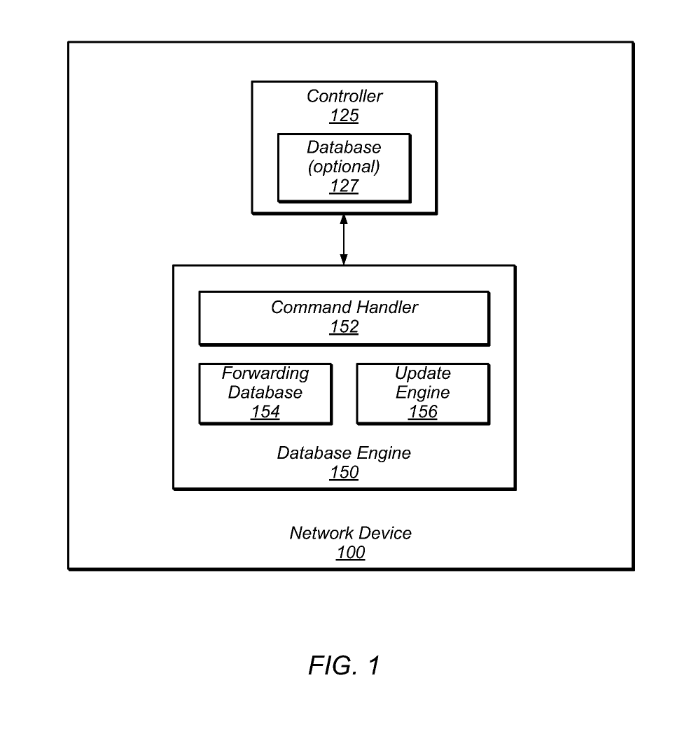

### FIG. 1—Exemplary Network Device

FIG. 1 is a block diagram of an exemplary network device 100, according to one embodiment. The network device 100 may be any of various networking devices, such as switches, routers, gateways, etc.

As shown in FIG. 1, the network device 100 may include a controller 125 and a database engine 150. In some embodiments, the controller 125 may be implemented, at least in part, by program instructions (e.g., one or more software programs) executing on a processor, e.g., a CPU of the network device 100. In some embodiments, the controller 125 may be implemented in hardware as a part of switch portion of the network device 100.

The database engine 150 may be implemented in hardware and may perform lower level switching functionality of the network device 100. The controller 125 may perform synchronization functions to retrieve changes from the database engine 150 to provide database information to upper layer management application(s) such as OAM functions or to use this information to configure another database engine by commands or messages. In some embodiments, the database engine 150 may be referred to as a switch portion of the network device 100.

The database engine 150 may include a command handler 152 (e.g., for processing commands, such as those provided by the controller 125), a forwarding database 154 (e.g., for performing routing/switching decisions), and an update engine 156 (e.g., for performing updates). The controller 125 may also include database 127, e.g., which may be synchronized with the forwarding database 154, as discussed herein. The database 127 and the forwarding database 154 may have an identical structure or may be different, as desired. For example, the forwarding database 154 may include fields for performing synchronization (e.g., as discussed herein) that may not be necessary or present in the database 127. Generally, descriptions herein apply to the synchronization of changes made to the forwarding database 154, e.g., during the normal course of operation, which are then propagated to the database 127. However, updates may occur in the opposite direction, from the controller 125 to the database engine 150, although such updates may occur in a different manner than as described herein. Additionally, note that the database 127 may be optional, but updates still may be received by the controller 125 as described below (e.g., and used for updating other databases, providing to upper level management applications, etc.). Thus, in some embodiments, the database 127 may not be required.

In some embodiments, the network device 100 may include a plurality of database engines 150 and the controller 125 may be coupled (e.g., control) some or all of them. For example, the controller 125 may receive updates from a first database engine and provide those updates to a second database engine, e.g., within the same network device. In some embodiments, the network device 100 may include a plurality of controllers 125 and a plurality of database engines 150, as desired. Additionally, the controller 125 may use its up-to-date database 127 to provide update information to other network devices, e.g., within the same network. Any of a variety of actions may be performed using the updated information in the database 127.

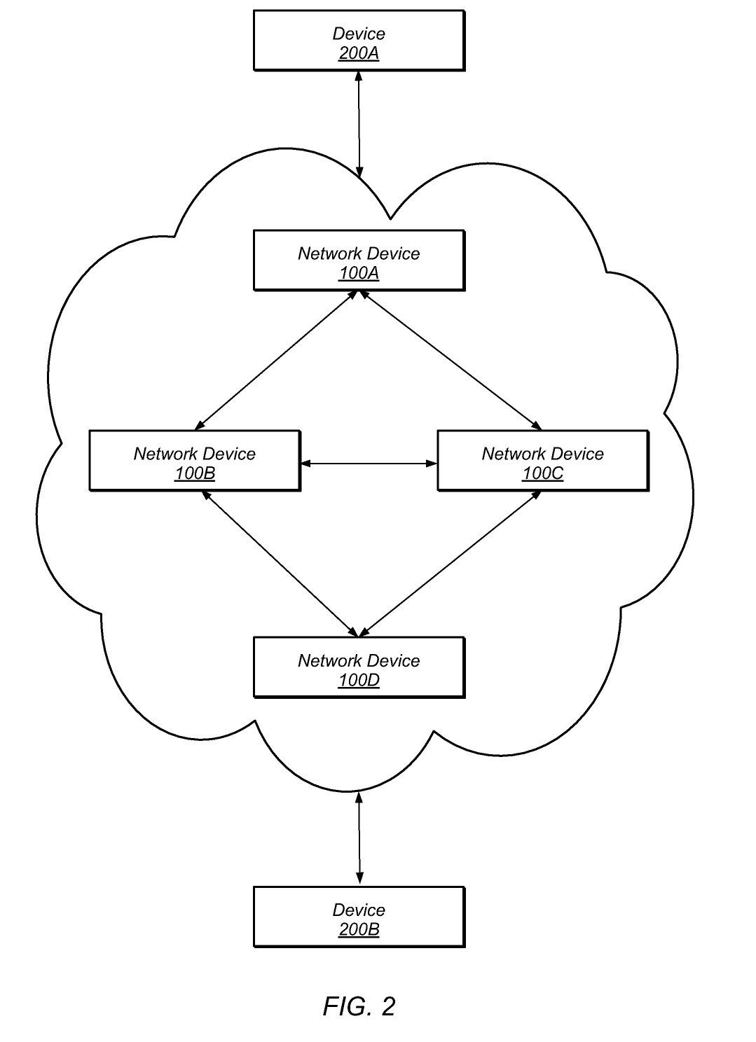

### FIG. 2—Exemplary Network Including a Plurality of Network Devices

FIG. 2 illustrates an exemplary network including a plurality of network devices 100A-100D. More specifically, devices 200A and 200B may be in communication using the network, which includes the network devices 100A-100D. The devices 200A and 200B may be any of a variety of devices capable of performing communication over a network, such as desktop computers, laptop computers, cell phones, tablets, netbooks, etc.

In one embodiment, the devices 200A and 200B may transmit packets into the network for communication. The network devices 100A-100D may receive those packets and perform routing or switching functionality to deliver the packets to their destination using a plurality of intermediary network devices.

During this process, various ones of the network devices 100A-100D may transmit updates or changes to their respective switching tables between themselves. For example, a controller of network device 100A may receive updates from its respective database engine and may provide these updates (and/or other information) to one or more of the network devices 100B-100D, e.g., to keep the network devices 100A-100D up to date. Similar behavior may be implemented by the network devices 100B-100D.

Additionally, the network may be implemented using a ring topology. For example, the network devices 100A-100D may be coupled and may communicate using a ring topology. Note that various ones of the connections of FIG. 2 may not be necessary or be used; for example, in one embodiment of a ring topology, the connection between network devices 100B and 100C may not exist. In some embodiments, the network devices may be stacked using a ring, in such a topology. Further topologies and connections are envisioned.

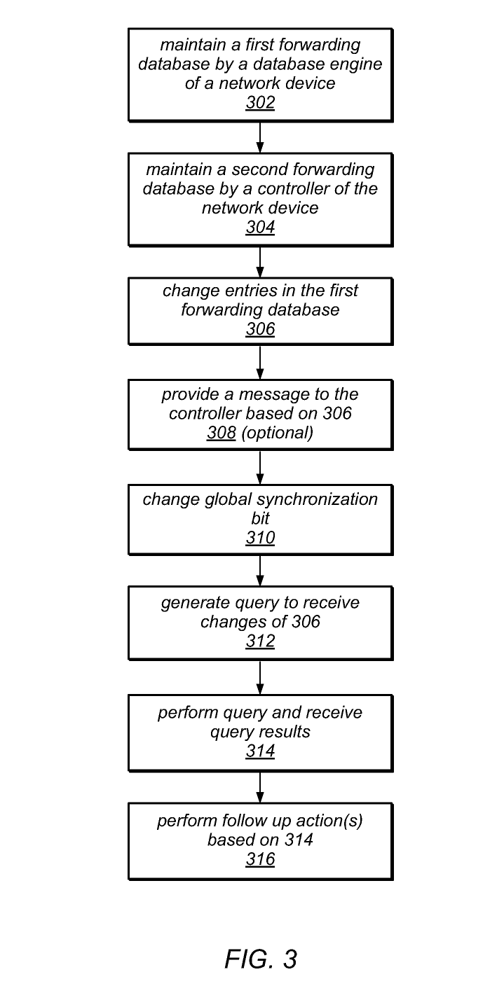

### FIG. 3—Synchronizing a Controller and a Database Engine in a Network Device

FIG. 3 illustrates a method for synchronizing a controller and database engine in a network device, according to one embodiment. The method shown in FIG. 3 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows

In 302, a first forwarding database or table may be maintained in a database engine portion of the network device. The database engine portion may be largely implemented in hardware.

Additionally, in 304, a second forwarding database or table may be maintained by a controller portion of the network device. The controller portion may be implemented as software executing on a processor of the network device. At a first time, the data between the two databases may be synchronized.

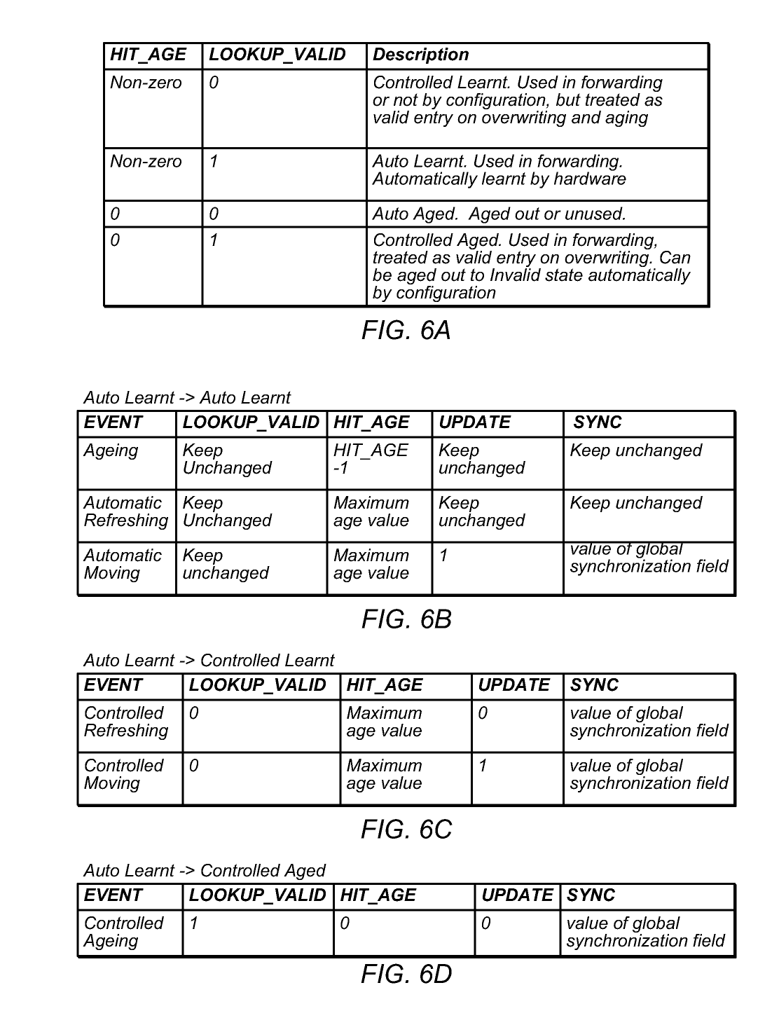

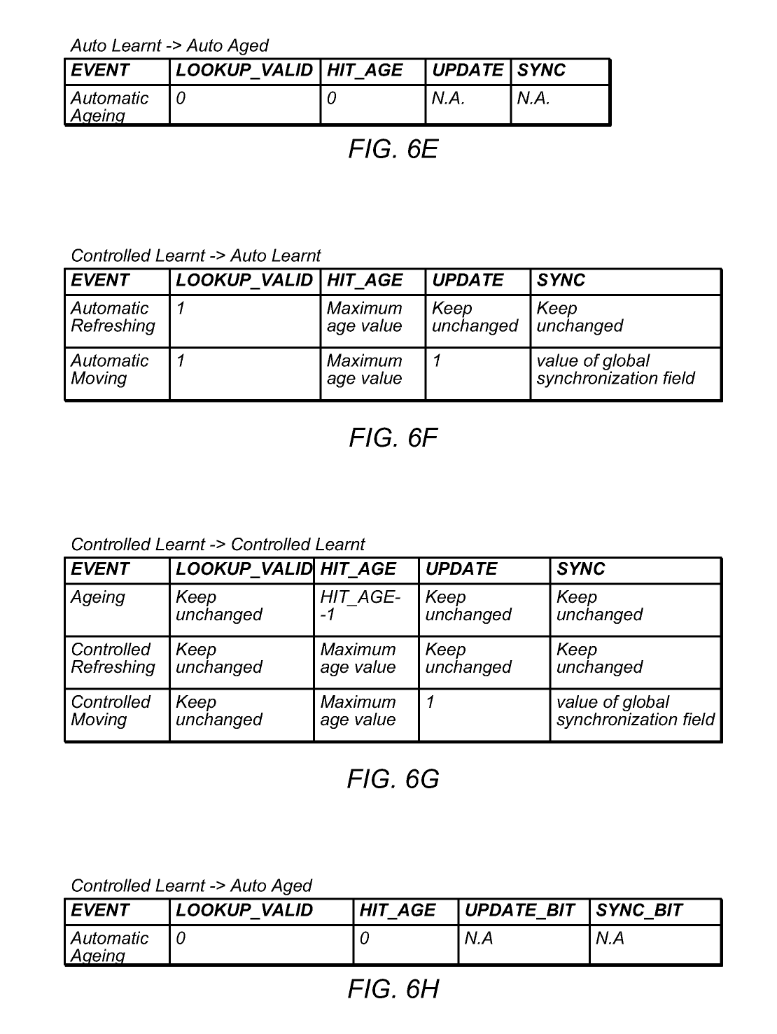

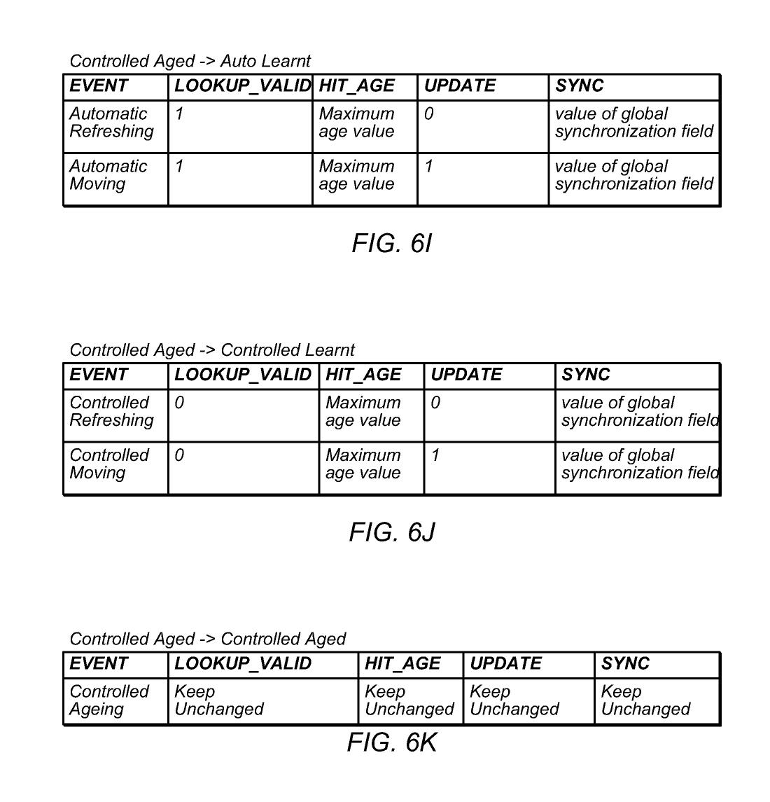

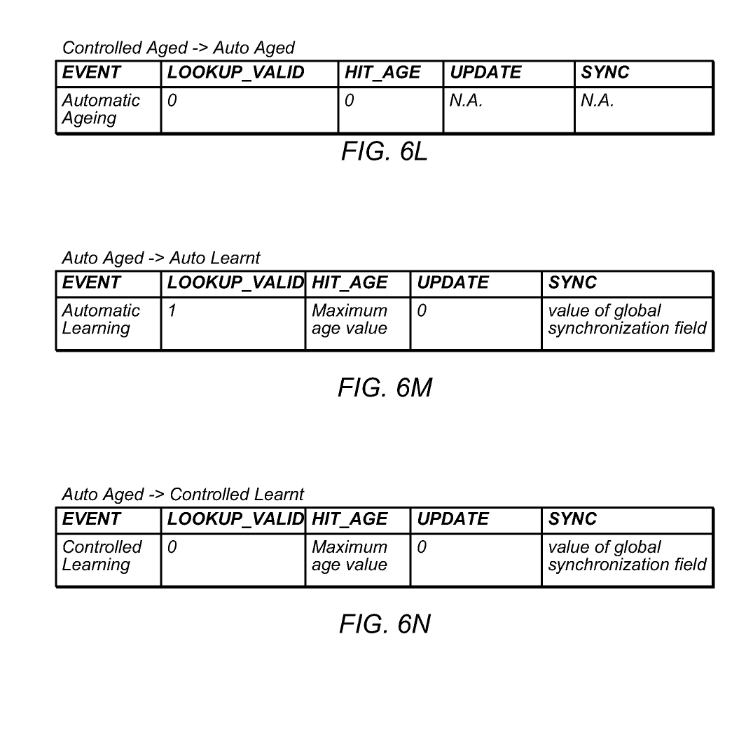

Both the first forwarding database and the second forwarding database may include a plurality of entries. In at least the first forwarding database, each of the plurality of entries may include a synchronization field, among other fields. The first and second forwarding databases may include or use a global synchronization value, e.g., for synchronizing changes of the first forwarding database to the second forwarding database, as discussed in more detail below. Additional fields may also be used for synchronization, such as an update field (e.g., to indicate when an existing field has been updated) and a learning or status field (e.g., to indicate the status of the entry, such as “auto learnt”, “controlled learnt”, “controlled aged”, and/or “auto aged”, among other possibilities). In some embodiments, the learning field may be implemented using a plurality of other fields, such as HIT_AGE and LOOKUP_VALID (e.g., which may be used to ascertain the state of the entry, such as “controlled learnt”). The descriptions regarding FIGS. 6A-6N may apply to this embodiment. Other fields may be used to assist in synchronization.

Note that one or more of the fields used in synchronization may only be present in the first forwarding database and not in the second forwarding database. For example, this synchronization information may not be necessary in the second forwarding database, e.g., since updates may generally occur in the database engine portion and then synchronized to the controller portion rather than the opposite direction. However, synchronization in the opposite direction is still envisioned, e.g., when updates are provided from other network devices. In one embodiment, such synchronizations may occur in a different manner than discussed herein.

During the course of operation, in 306, changes may occur in the first forwarding database, e.g., entries may be changed or added by the database engine portion of the database. In one specific embodiment, changes to a first one or more entries in the first forwarding database may be performed. These changes may include the addition of entries or the modification of values of fields in existing entries. Additionally, these entries may have a synchronization value set to the current synchronization value. Accordingly, at a second time, the first and second databases may become out of synchronization.

In response to these changes, or in a periodic fashion, the database engine portion may send a message, such as an interrupt, to the controller to indicate that an update of the second forwarding database should be performed. Accordingly, in 308, the controller in the network device may receive a message indicating that changes have occurred in the first forwarding database.

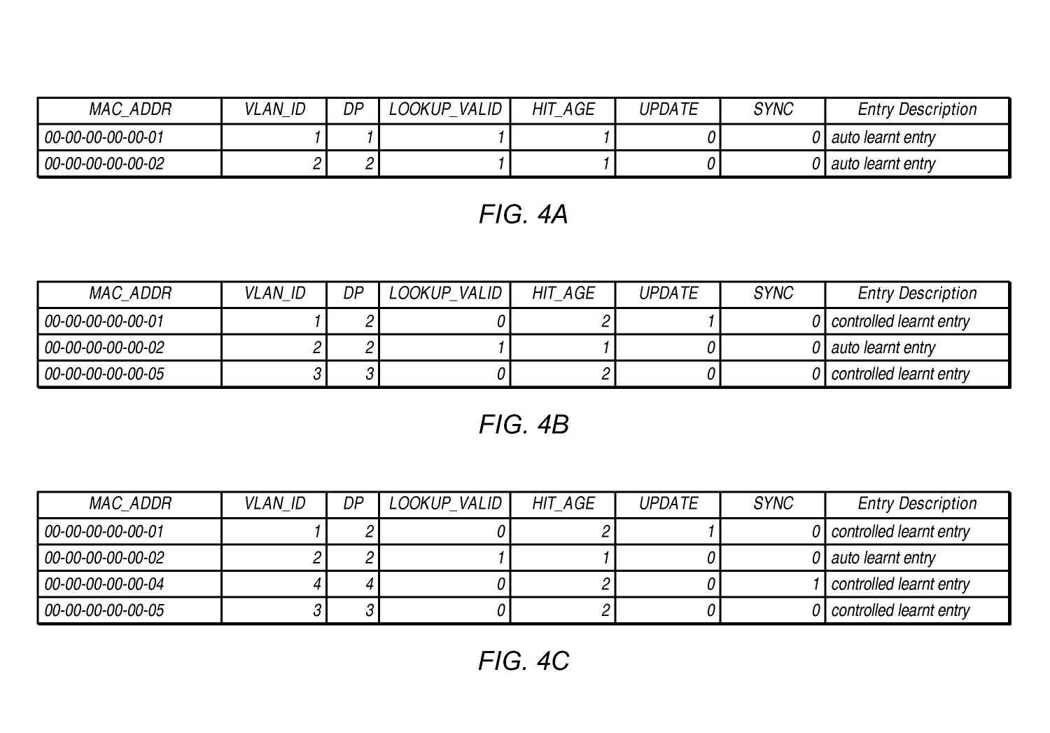

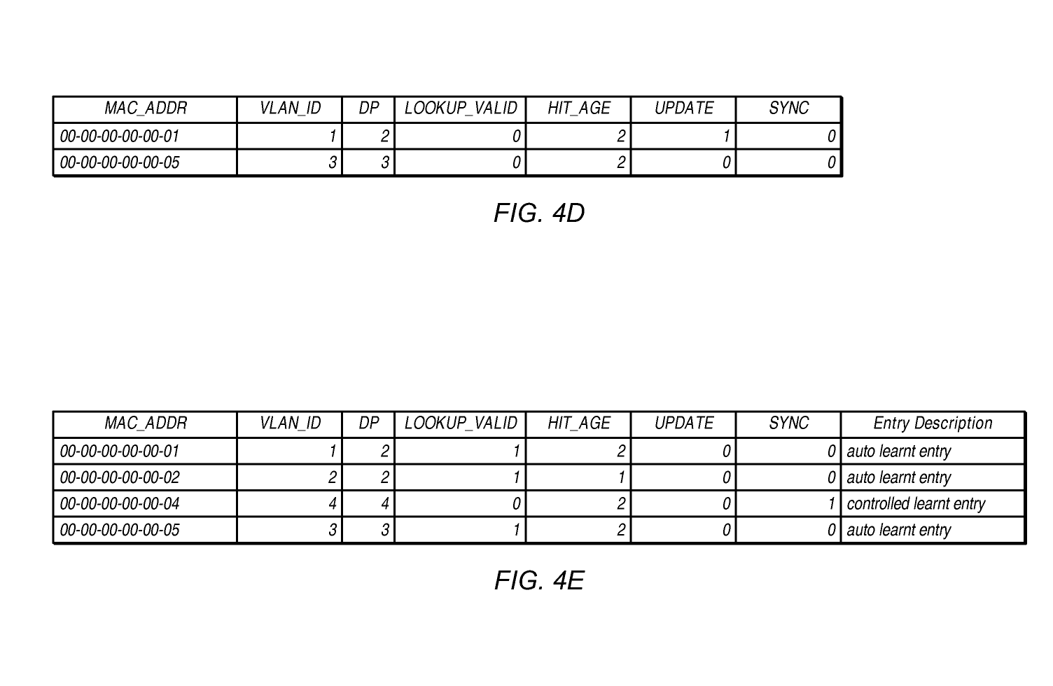

In response, in 310, the global synchronization value may be changed (e.g., by the controller) from the first global synchronization value to a second global synchronization value. Additionally, in 312, a query may be generated (e.g., by the controller) to determine the one or more changes to the first entries in the first forwarding database. In one embodiment, the query may include or use various values associated with fields in the first forwarding database, such as the global synchronization value, the update value, the status value, etc. In one embodiment, the query may search for those entries having the first global synchronization value and a status field of “controlled learnt”. However, it should be noted that embodiments are envisioned where any combination of the global synchronization value, the update value, or the status value (among other possible fields) may be used. An example of this process is provided in more detail below, regarding FIGS. 4A-4E.

Accordingly, in 314, the query may be performed to return query results (e.g., from the database engine portion to the controller portion). The query results may include the one or more changes to the first one or more entries, e.g., by using the first global synchronization value and/or the other values discussed above to identify the first one or more entries.

After the query results have been obtained, various follow up actions may be performed in 316. For example, various ones of the fields, e.g., in the first forwarding database, may be reset. For example, entries that have been synchronized may change the update field value from, e.g., “1” (enabled) to “0” (disabled). Similarly, entries that have a status value of “controlled learnt” may be changed to “auto learnt”, e.g., so that they are not returned in a future query for changes made to the first forwarding database.

Additionally, the query results may be used in a variety of manners. As indicated above, the controller may maintain a second forwarding database and may used the query results to update the second forwarding database (e.g., to synchronize the first and second forwarding databases). As another possibility, the query results may be used to update other network devices or other database engine portions of the network device (e.g., where the network device includes a controller portion and several database engine portions, which may need to have their respective forwarding databases synchronized).

In one embodiment, changes to other entries in the forwarding database that occur after the controller changes the global synchronization value to the second global synchronization value are not part of the query results, e.g., since those values may be assigned the second global synchronization value rather than the first. In these cases, when the changes (e.g., modifications or additions) are made, their synchronization fields may be set to the current global synchronization value (which, in this example, is the second global synchronization value), so that these changes may be identified in a subsequent synchronization process. Thus, the global synchronization value may “ping pong” between two different values over the course of several synchronizations to track which entries have or have not been synchronized.

### FIGS. 4A-4E—Exemplary Tables Corresponding to the Method of FIG. 3

FIGS. 4A-4E are exemplary tables of a forwarding or filtering database in an Ethernet switch, corresponding to the method of FIG. 3. These tables and the following descriptions are provided as exemplary details only and are not intended to limit the scope of the systems and methods described above.

For FIGS. 4A-4E, there are two entities: the database engine and the controller. To synchronize the database with the controller, every entry in the forwarding (or filtering) database of the database engine may include a synchronization field. The database engine may update records by changing a global synchronization value and informing the controller of a pending change. The controller may then change the value of the global synchronization field and search the forwarding database based on the previous value of the global synchronization field.

For the database synchronization, an update field may be used to differentiate between updating and creating an entry. When updated, the “UPDATE” field of the entry may be enabled (e.g., by changing the value from “0” to “1”). After synchronization, the controller may clear this field (e.g., by changing the value from “1” to “0”). In one embodiment, the controller may search the database by the old value of the global synchronization field and the value of the UPDATE field.

In more detail, the database engine may include a search engine for searching the entries by single property or combination of LOOKUP_VALID, HIT_AGE, and UPDATE fields and/or other needed FDB information. To synchronize entry creations and updates on the database, the engine may inform the controller by CTRL_LRN (controlled learnt) interrupt or message. The controller may then change the global synchronization value from 0 to 1 or vice versa. The engine may then perform controlled learning by creating or updating the entry with the SYNC field equaling to the new value of the global learning synchronization field.

To synchronize updates to entries, the controller may search the engine by the condition including the UPDATE field equaling to 1 and the SYNC field equaling to the previous value of the global learning synchronization field to get all updated entries. The controller may clear the UPDATE field of all these entries after synchronization. To synchronize creations of entries, the controller may then use the condition including the UPDATE field equaling to 0 and the SYNC field equaling to the previous value of the global learning synchronization field. Thus, in some embodiments, the query discussed above may be implemented as a plurality of queries or a compound query, as desired.

To synchronize deletions of entries, the engine may inform the controller by CTRL_AGE (controlled aged) interrupt or message. The controller may then change the global ageing value from 0 to 1 or vice versa. The engine may perform controlled ageing by updating the entry with the SYNC field equaling to the new value of the global ageing synchronization field. The controller may then use the condition including the LOOKUP_VALID field equaling 1 and HIT_AGE field equaling to 0 and the SYNC field equaling to the previous value of the global learning synchronization field to get all aged-out entries. The controller can delete these entries, e.g., by sending a command with the condition including the LOOKUP_VALID field equaling 1 and HIT_AGE field equaling to 0 and the SYNC field equaling to the previous value of the global learning synchronization field after the synchronization.

FIG. 4A illustrates an exemplary forwarding table at a first point in time, e.g., where the tables of the controller and the database engine are synchronized. In this table, two different entries are currently stored, one for MAC address 00 00 00 00 00 01 and another for MAC address 02.

In FIG. 4B, the entry for 01 has been updated to change the field “DP” from “1” to “2”, the field “LOOKUP_VALID” from “1” to “0”, the field “HIT_AGE” from “1” to “2”, the field “UPDATE” from “0” to “1” (indicating a change has occurred), and the status field “Entry Description” from “auto learnt entry” to “controlled learnt entry” (e.g., indicating the entry is in a pending state—using this entry in forwarding process or not may be configurable). Additionally, a new entry, 00 00 00 00 00 05, has been added, which has the status field value of “controlled learnt entry” for the same reasons as for 01 above. Additionally, as shown in FIG. 4B, all entries have a synchronization value of “0”.

As described above, in response to these changes to the forwarding table, a message (e.g., an interrupt) may be provided to the controller. In response, the global synchronization field may be changed from “0” to “1”, so that changes made after synchronization have begun may be identified for a later synchronization.

In FIG. 4C, during the synchronization, a new entry, “00 00 00 00 00 04” has been added. As shown, because the global synchronization value was changed upon initiation of the synchronization, the new entry is assigned the synchronization value of “1”. Without this change, the entry “00 00 00 00 00 04” may be omitted in a later synchronization.

FIG. 4D illustrates the results of the query for the updated entries. As shown, the query returns both 00 00 00 00 00 01, which was modified above, and 00-00-00-00-00-05, which was added. In one embodiment, the query may be based on the status field value (e.g., having the status “controlled learnt entry” or not “auto learnt entry”), the global synchronization value (e.g., having the value “0”), and/or the update value (e.g., having a value of “1”). In one embodiment, the query may be the union of the global synchronization value and the update value as well as the global synchronization value and the status value.

After synchronization, the newly synchronized entries may be updated, as shown in FIG. 4E. More specifically, the UPDATE field for entry 01 may be reset to “0” and the status field values may be set to “auto learnt entry” from “controlled learnt entry” for entries 00 00 00 00 00 01 and 00 00 00 00 00 05. In the next round of synchronization, the global synchronization value used may be “1” rather than “0”. Thus, the global synchronization value may “ping pong” between “1” and “0” in order to keep track of the entries that are synchronized.

In the above example, there are two states for learning: controlled learnt may be used for hardware learning before synchronization. After that, the state may be changed to auto learnt by a command from the controller. Additionally, the update field may be used to show the destination port of the entry has been changed. This change may be useful when the controller needs to know changes to some specific ports, e.g., both new created and moved to another port.

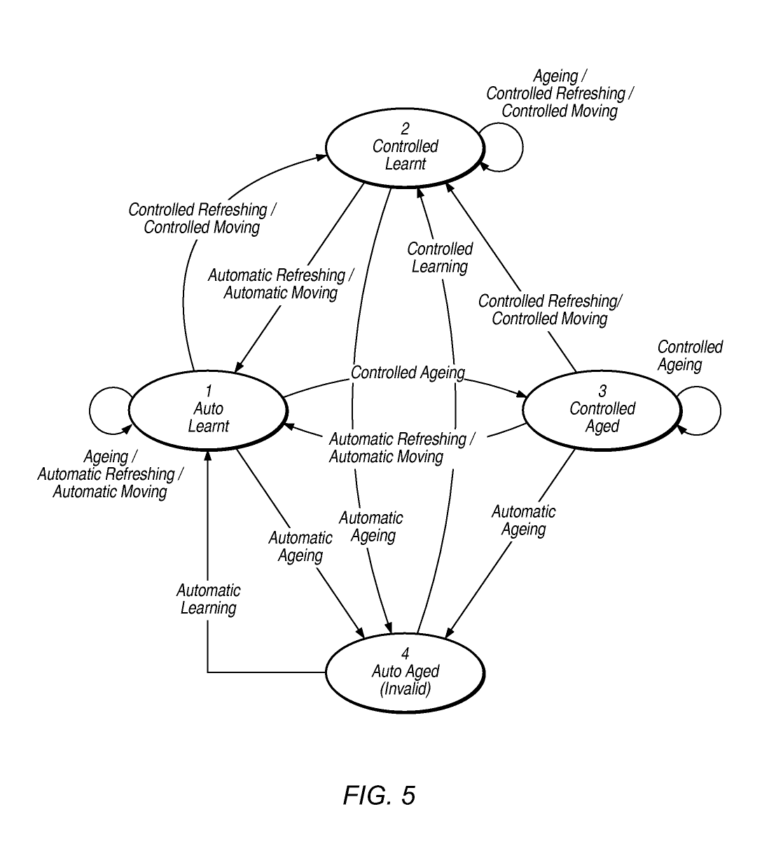

### FIGS. 5 and 6A-6N—Exemplary State Diagram and Tables

FIG. 5 illustrates an exemplary state diagram corresponding to entries of a forwarding database (FDB), (e.g., of the database engine in an Ethernet switch). FIGS. 6A-6N are exemplary tables illustrating concepts of the state diagram of FIG. 5. These descriptions provide exemplary details related to those provided above, e.g., regarding ageing of entries as well as other processes.

As shown in FIG. 5, entries may have the states “auto learnt”, “controlled learnt”, “controlled aged”, and “auto aged (invalid)”. The entries may transition between these states in the manner shown in FIG. 5, e.g., being automatically aged to enter the “auto aged” state, being automatically learned to entry the “auto learnt” state, etc. The following provides further details on the events shown in FIG. 5 and included in tables 6A-6N:

Controlled Learning: Ingress port/virtual port (the destination port in the entry) is configured to controlled learning mode. The FDB entry does not exist and the database engine may add this entry as a new one.

Controlled Refreshing: Ingress port/virtual port (the destination port in the entry) is configured to controlled learning mode. The FDB entry exists and the destination port is the same one as the current ingress port/virtual port.

Controlled Moving: Ingress port/virtual port (the destination port in the entry) is configured to controlled learning mode. The FDB entry exists and the destination port is not the same one as the current ingress port/virtual port.

Automatic Learning: Ingress port/virtual port (the destination port in the entry) is configured to automatic learning mode. The FDB entry does not exist and the database engine may add this entry as a new one.

Automatic Refreshing: Ingress port/virtual port (the destination port in the entry) is configured to automatic learning mode. The FDB entry exists and the destination port is the same one as the current ingress port/virtual port.

Automatic Moving: Ingress port/virtual port (the destination port in the entry) is configured to automatic learning mode. The FDB entry exists and the destination port is not the same one as the current ingress port/virtual port.

Ageing: Decrease the HIT_AGE by 1 to an above 0 value. The ageing is either automatic aged or controlled aged. The state of the entry is kept unchanged.

Controlled Ageing: Ingress port/virtual port (the destination port in the entry) is configured to Controlled Ageing mode. Decrease the HIT_AGE by 1 to 0.

Automatic Ageing: Ingress port/virtual port (the destination port in the entry) is configured to Automatic Ageing mode. Decrease the HIT_AGE by 1 to 0.

In one particular embodiment, there may be two properties associated with each entry: the age value and the valid value. These two properties may represent the four states for each entry shown in FIG. 6A. As shown, if the HIT_AGE field is above 0, the state may be “controlled learnt” or “auto learnt”. If the HIT_AGE is 0 and the valid value is 0, the entry may be invalid. If the HIT_AGE is 0 and the valid value is still 1, the entry may be in the state “controlled aged”. Generally, the HIT_AGE value may be decremented each ageing cycle until it reaches zero.

To record a change to a port/virtual port, Controlled Learning and Controlled Ageing may be enabled. The FDB (forwarding database) engine may have two global values to record the current synchronization state of learning and ageing. This engine may perform controlled learning by creating or updating the entry for a frame and record the SYNC field based on the value of the global learning synchronization field. The controlled ageing may update the SYNC field based on the value of the global ageing synchronization field when the age value reaches zero. There may also be a UPDATE field in every entry indicating whether the entry was updated in the previous synchronization.

FIG. 6B illustrates the state transition between “auto learnt” and “auto learnt”. This may occur when the ingress port/virtual port of the frame that triggers the learning is set to automatic learning mode. Note that when ageing and refreshing, UPDATE field and SYNC field may remain unchanged or the update may be lost.

FIG. 6C illustrates the state transition between “auto learnt” and “controlled learnt”. This may occur when the ingress port/virtual port of the frame that triggers the learning is set to controlled learning mode.

FIG. 6D illustrates the state transition between “auto learnt” and “controlled aged”. This may occur when the destination port of the entry is set to controlled ageing mode and the ageing process decreases the age value to zero.

FIG. 6E illustrates the state transition between “auto learnt” and “invalid”. This may occur when the destination port of the entry is set to automatic ageing mode and the ageing process decrease the age value to zero.

FIG. 6F illustrates the state transition between “controlled learnt” and “auto learnt”. This may occur when the ingress port/virtual port of the frame that triggers the learning is set to automatic learning mode. Note that when ageing and refreshing, UPDATE field and SYNC field may remain unchanged or the update may be lost.

FIG. 6G illustrates the state transition between “controlled learnt” and “controlled learnt”. This may occur when the destination port of the entry is set to controlled learning mode. Note that when ageing and refreshing, UPDATE field and SYNC field may remain unchanged or the update may be lost.

FIG. 6H illustrates the transition between “controlled learnt” and “invalid”. This may occur when the destination port of the entry is set to automatic ageing mode and the ageing process decreases the age value to zero.

FIG. 6I illustrates the transition between “controlled aged” and “auto learnt”. This may occur when the destination port of the entry is set to automatic learning mode.

FIG. 6J illustrates the transition between “controlled aged” and “controlled learnt”. This may occur when the destination port of the entry is set to controlled learning mode.

FIG. 6K illustrates the transition between “controlled aged” and “controlled aged”. This may occur when the destination port of the entry is set to controlled ageing mode and the ageing process has already decreased the age value to zero.

FIG. 6L illustrates the transition between “controlled aged” and “invalid”. This may occur when the destination port of the entry is set to automatic ageing mode and the ageing process decreases the age value to zero.

FIG. 6M illustrates the transition between “invalid” and “auto learnt”. This may occur when the ingress port/virtual port of the frame that triggers the learning is set to automatic learning mode.

FIG. 6N illustrates the transition between “invalid” and “controlled learnt”. This may occur when the ingress port/virtual port of the frame that triggers the learning is set to controlled learning mode.

### FURTHER DESCRIPTIONS

The following provides further details of one specific embodiment. However, similar to above, these descriptions are provided as examples only and are not intended to limit the scope of the embodiments discussed above.

MAC address learning and ageing:

MAC address learning and ageing may be supported in FDB table.

Each FDB entry may include a LOOKUP_VALID field. When the LOOKUP_VALID field is set to 1, the entry is available for use; when set to 0, the entry is not involved in any switching and forwarding processing.

Each FDB entry includes an HIT_AGE value which may define the life time of the MAC address. The ageing process decreases the life value of the MAC address while the learning process refreshes the life value when an (SA (Source MAC Address), VID) matches the entry during the learning process.

The key (SA, VID) may be used for FDB lookup. If no match is found, the SA may be recognized as an Unknown SA and may be added as a New Address to the FDB table by hardware, given that the automatic learning mode or controlled learning mode is enabled.

The learnt MAC address may be stored in FDB according to the hash value of (SA, VID) key.

MAC address learning:

When the (SA, VID) is not found in the FDB during the learning lookup, the address may be regarded as Unknown. If the FDB has enough space, the address may be learnt and added to FDB table automatically by hardware. The HIT_AGE may be set to the maximum age value.

MAC address refreshing:

When the (SA, VID) is found in the FDB and the destination port is the same one as the current ingress port/virtual port. The HIT_AGE in the found entry may be updated to the maximum age value

MAC address moving:

When the (SA, VID) is found in the FDB and the destination port is not the same one as the current ingress port/virtual port. The HIT_AGE in the found entry may be updated to the maximum age value

Two MAC address learning modes may be used in MAC address learning. For example, refreshing and moving may be supported and may be configured per port or per VLAN or both, which are automatic learning mode and controlled learning mode. The learning mode may not only be used for MAC address learning, but also may be used as the mode for MAC address entry refreshing or moving.

Automatic learning mode:

The entry may be added or updated with the LOOKUP_VALID set to 1.

Controlled learning mode:

The entry may be added or updated with the LOOKUP_VALID set to 0. The entry may not be used in switching and forward process until controller or software set the LOOKUP_VALID field to 1.

MAC address ageing:

MAC address ageing may be used to delete non-active entries. The HIT_AGE value may be decreased by 1 automatically by hardware after a configurable interval before it is aged out, which means that the HIT_AGE value reaches 0.

The following MAC address ageing modes may be supported: automatic ageing mode and controlled ageing mode.

Automatic ageing mode:

The learnt MAC address may be aged out automatically regardless whether the entry was learnt by hardware automatic learning process or by controlled learning process. The aged-out entry may be deleted from the FDB table.

Controlled ageing mode:

In controlled ageing mode, valid entry may not be aged out unless it is deleted by the controller or by the automatic ageing process.

### Advantages of the Present Embodiments

Using various embodiments described above, the use of a FIFO queue (or similar queues) may no longer be necessary for performing updates between database or tables in a network device. Additionally, the learning speed may generally be improved without limiting the depth of a FIFO queue.

Another advantage when using various embodiments, the capability of the controller and the database engine may be decoupled (e.g., completely). Thus, in one embodiment, the controller can perform the synchronization when it is able (e.g., when it is free) without degrading the performance of the database engine.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A computer-implemented method for receiving updates of a forwarding database of a network device, the method comprising:
maintaining the forwarding database in a database engine portion of the network device, wherein the forwarding database comprises a plurality of entries, wherein each of the plurality of entries comprises a synchronization field, wherein the forwarding database comprises a global synchronization value;
a controller changing the global synchronization value to a second global synchronization value and generating a query to determine one or more changes to a first one or more entries in the forwarding database, wherein the first one or more entries have a first global synchronization value in the synchronization field;
performing the query to return query results, wherein the query results comprise the one or more changes to the first one or more entries, wherein said performing uses the first global synchronization value to identify the first one or more entries.

2. The computer-implemented method of claim 1, further comprising:
the controller in the network device receiving a message indicating the one or more changes to the first one or more entries in the forwarding database, wherein said changing the global synchronization value is performed in response to the message.

3. The computer-implemented method of claim 1, wherein changes to other entries in the forwarding database that occur after the controller changing the global synchronization value to the second global synchronization value are not part of the query results

4. The computer-implemented method of claim 1, further comprising:
updating a controller database in the controller based on the query results.

5. The computer-implemented method of claim 1, further comprising:
the controller providing updates to one or more other network devices based on the query results.

6. The computer-implemented method of claim 1, further comprising:
maintaining a controller database in the controller;
updating the controller database using the query results; and
performing said receiving the message, said changing the global synchronization value, said performing the query, and said updating the controller database a plurality of times to synchronize the controller database and the forwarding database.

7. The computer-implemented method of claim 1, wherein the query comprises the first global synchronization value.

8. The computer-implemented method of claim 1, wherein each of the plurality of entries comprises an update field, wherein the query comprises a value for the update field to determine at least one of the one or more changes to the first one or more entries.

9. The computer-implemented method of claim 1, wherein each of the entries comprise a learning field, wherein the method further comprises:
modifying at least one entry of the first one or more entries to be associated with a state indicating a change by the database engine, wherein said receiving the message is performed in response to said modifying, and wherein the query results are based on the at least one entry having the state;
after performing the query, changing the state for the at least one entry to a different state.

10. The computer-implemented method of claim 1, further comprising:
after changing the global synchronization value, modifying a second entry in the forwarding database, wherein the synchronization field of the second entry comprises the second global synchronization value, wherein the query results do not comprise the second entry based on the second global synchronization value.

11. The computer-implemented method of claim 10, further comprising:
in response to a second message, the controller changing the global synchronization value to the first global synchronization value and generating a second query to determine one or more additional changes; and
performing the second query to return second query results, wherein the second query results comprise the new entry.

12. The computer-implemented method of claim 1, further comprising:
the controller changing the global synchronization value between the first global synchronization value and the second global synchronization value and generating queries using previous global synchronization values to determine new changes in the forwarding database a plurality of times.

13. A network device, comprising:
a database engine, wherein the database engine is configured to maintain a first forwarding table, wherein the forwarding database comprises a plurality of entries, wherein each of the plurality of entries comprises a synchronization field, wherein the forwarding database comprises a global synchronization value;
a controller coupled to the database engine, wherein the controller is configured to:
change the global synchronization value to a second global synchronization value;
generate a query to determine one or more changes to a first one or more entries in the forwarding database using the first global synchronization value, wherein the first one or more entries have a first global synchronization value in the synchronization field;
receive query results from the database engine, wherein the query results comprise the one or more changes to the first one or more entries, wherein said performing uses the first global synchronization value to identify the first one or more entries; and
wherein changes to other entries in the forwarding database that occur after the controller changing the global synchronization value to the second global synchronization value are not part of the query results.

14. The network device of claim 13, wherein the controller is further configured to:
store a second forwarding table corresponding to the first forwarding table; and
update the second forwarding table based on the query results;

15. The network device of claim 13, wherein the controller is further configured to provide updates to one or more other network devices based on the query results.

16. The network device of claim 13, wherein the controller is further configured to:
receive a message indicating one or more changes to a first one or more entries in the first forwarding table, wherein said changing the global synchronization value is performed in response to receiving the message.

17. The network device of claim 13, wherein the controller is further configured to perform said receiving the message, said changing the global synchronization value, said receiving the query results, and said updating the second forwarding table a plurality of times to synchronize the second forwarding table with the first forwarding table.

18. The network device of claim 13, wherein each of the plurality of entries comprises an update field, wherein at least one entry of the first one or more entries comprise a first value in the update field indicating a change of the at least one entry, wherein the query results are based on the first value of the update field.

19. The network device of claim 13, wherein each of the entries comprise a learning field, wherein the database engine is configured to:
modifying at least one entry of the first one or more entries to be associated with a state indicating a change by the database engine, wherein said receiving the message is performed in response to said modifying, and wherein the query results are based on the at least one entry having the state;
perform the query to provide the query results; and
after performing the query, changing the state for the at least one entry to a different state.

20. A non-transitory, computer accessible memory medium storing program instructions for receiving updates from a forwarding database in a network device, wherein the program instructions are executable by a processor to:
receive a message indicating one or more changes to the a first one or more entries in the forwarding database, wherein the forwarding database comprises a plurality of entries, wherein each of the plurality of entries comprises a synchronization field, wherein the forwarding database comprises a global synchronization value, wherein the first one or more entries have a first global synchronization value in the synchronization field;
change the global synchronization value to a second global synchronization value;
generate a query to determine the one or more changes to the first one or more entries in the forwarding database, wherein the query comprises the first global synchronization value to identify the first one or more entries;
receive query results of the query, wherein the query results comprise the one or more changes to the first one or more entries, wherein said performing uses the first global synchronization value to identify the first one or more entries, wherein changes to other entries in the forwarding database that occur after the said changing the global synchronization value to the second global synchronization value are not part of the query results.

21. The non-transitory, computer accessible memory medium of claim 20, wherein the program instructions are executed by a processor of a controller of the network device, and wherein the message is received from a database engine of the network device.

22. The non-transitory, computer accessible memory medium of claim 20, wherein the program instructions are further executable to:
maintain a second forwarding database corresponding to the forwarding database; and
update the second forwarding database based on the query results.

23. A method for providing updates of a forwarding database of a network device, comprising:
maintaining the forwarding database in a database engine portion of the network device, wherein the forwarding database comprises a plurality of entries, wherein each of the plurality of entries comprises a synchronization field, wherein the forwarding database comprises a global synchronization value;
modifying a first one or more entries in the forwarding database, wherein the first one or more entries have a first global synchronization value in the synchronization field
modifying the global synchronization value to a second global synchronization value in response to a command from the controller;
performing a query of the forwarding database using the first global synchronization value, wherein the query comprises one or more changes to the first one or more entries, wherein changes to other entries in the forwarding database that occur after said modifying the global synchronization value to the second global synchronization value are not part of the query results; and
providing the query results to the controller.

24. The method of claim 23, further comprising:
providing a message to a controller in the network device indicating changes to the forwarding database;

25. The method of claim 23, wherein the controller maintains a second forwarding database, wherein the controller is configured to use the query results to update the second forwarding database.

26. The method of claim 23, wherein the controller is configured to use the query results to update the forwarding database in other database engine.

27. The method of claim 23, wherein the controller is configured to use the query results to send messages to another controller to update an associated database engine.

28. A system for receiving updates of a forwarding database of a network device, the system comprising:
means for maintaining the forwarding database in a database engine portion of the network device, wherein the forwarding database comprises a plurality of entries, wherein each of the plurality of entries comprises a synchronization field having a synchronization value, wherein the forwarding database comprises a global synchronization value;
means for changing the global synchronization value to a second global synchronization value and generating a query to determine one or more changes to a first one or more entries in the forwarding database, wherein the first one or more entries have a first global synchronization value in the synchronization field;
means for performing the query to return query results, wherein the query results comprise the one or more changes to the first one or more entries, wherein said performing uses the first global synchronization value to identify the first one or more entries.
